(19) United States
(12) Patent Application Publication
(10) Pub. No.: US 2015/0269501 A1
(43) Pub. Date: Sep. 24, 2015

(54) SYSTEM AND PROCESS FOR RESOURCE ALLOCATION TO RELOCATE PHYSICAL OBJECTS

(71) Applicant: Ghostruck Co, Bellevue, WA (US)

(72) Inventors: Nathanael Nienaber, Bellevue, WA (US); Matthew Hocking, Seattle, WA (US)

(21) Appl. No.: 14/639,304

(22) Filed: Mar. 5, 2015

Related U.S. Application Data
(60) Provisional application No. 61/955,072, filed on Mar. 18, 2014.

(51) Int. Cl. G06Q 10/06

(52) U.S. Cl. CPC G06Q 10/0631

(57) ABSTRACT

A machine server system includes a video processor adapted with logic to identify a physical object representation in a video, an object fingerprinter adapted to assign an object type to the physical object representation, a resource allocator adapted to match the object type to pre-defined relocation resource values for physical objects having the object type, and weighting logic adapted to adjust the pre-defined relocation resource values for physical objects having the object type by an adjustment amount that varies according to geolocation coordinates correlated to the physical object representation.

### CROSS-REFERENCE TO RELATED APPLICATIONS

This application claims priority and benefit under 35 U.S.C. 119 to application U.S. Ser. No. 61/955,072, filed on Mar. 18, 2014, which is incorporated herein by reference in its entirety.

### BACKGROUND

The average person cannot accurately assess the dimensions and weights of freight items to be moved in order to estimate moving resources. The means that estimates on the resources of a move typically are inefficient or inaccurate.

### BRIEF SUMMARY

In some embodiments, a machine server system may include a video processor adapted with logic to identify a physical object representation in a video, an object fingerprinter adapted to assign an object type to the physical object representation, a resource allocator adapted to match the object type to pre-defined relocation resource values for physical objects having the object type, and/or weighting logic adapted to adjust the pre-defined relocation resource values for physical objects having the object type by an adjustment amount that varies according to geolocation coordinates correlated to the physical object representation.

In some embodiments, such a machine server system may further include a perimeterizer to identify a perimeter of the physical object representation in the video.

In some embodiments, such a machine server system may further include the object fingerprinter identifying a group of identification points in the physical object representation and transforming the group of identification points in the physical object representation into an object fingerprint.

In some embodiments, such a machine server system may further include the object fingerprinter comparing the object fingerprint to each of a group of pre-defined object fingerprints in an object database.

In some embodiments, such a machine server system may further include the adjustment amount varying with a two-dimensional distance between the geolocation coordinates correlated to the physical object representation and a relocation reference point.

In some embodiments, such a machine server system may further include the adjustment amount varying with an elevation distance between the geolocation coordinates correlated to the physical object representation and a relocation reference point.

### BRIEF DESCRIPTION OF THE SEVERAL VIEWS OF THE DRAWINGS

To easily identify the discussion of any particular element or act, the most significant digit or digits in a reference number refer to the figure number in which that element is first introduced.

FIG. 1 is a system diagram of an embodiment of a physical resource allocation system.

FIG. 2 is an action flow diagram of an embodiment of a physical resource allocation process.

FIG. 3 is a flow chart of an embodiment of a physical resource allocation process.

FIG. 4 is a system diagram of an embodiment of a relocation resource allocation system.

FIG. 5 is an action flow diagram of an embodiment of a relocation resource allocation process.

FIG. 6 is a flow chart of an embodiment of a relocation resource allocation process.

FIG. 7 is a figure describing a new drawing.

FIG. 8 is a figure describing a new drawing.

### DETAILED DESCRIPTION

### Glossary

“Digital Video (or just ‘video’)” in this context refers to pixels (e.g., images or frames) that are represented by binary data (bits) that describe a finite set of color and luminance levels. Communicating a digital video signal involves the conversion of optical incident light to digital information that is transferred to a digital video receiver. The digital information contains characteristics of the video signal and the position of the image (bit location) that will be displayed. Herein “video” is meant to encompass one or more still images as well as continuous streamed video frames.

“Image” in this context refers to information captured and stored by a device representing a visual perception, usually a two-dimensional picture. Images may be captured, stored, and communicated by devices in either analog or digital formats. The terms ‘photo’ or ‘photograph’ may also refer to an image.

### Description

In one embodiment a machine system interacts with a mobile device application to record and analyze a photograph(s) or video of one or more objects (freight) to be moved. The system identifies the freight (specifically or by type) and quantifies moving resources utilizing machine logic and interactions. The system generates resource estimates for relocating the freight based on associated attributes such as weight and physical dimensions. These physical attributes can be combined with machine inputs such the move origin and destination to produce a resource estimate to move that freight.

In one embodiment, the system interfaces with a mobile device camera to facilitate estimation of the resource allocation to move an object or group of objects from point A to point B. A photograph, or collection of photographs, or video are recorded using a mobile device, and machine inputs captured from the mobile device about the move and the objects applied to produce estimates of packaging and move costs.

An automated process implemented through the interaction of client device logic and logic within a machine network provides estimation of the resources required to move physical objects, possibly including itemizing packing materials needed. Delays and costs of less efficient processes are reduced or eliminated.

One implementation of the system utilizes (A) smartphones/tablet devices equipped with a camera, (B) internet connectivity and the ability to execute a mobile application that can communicate with (C) an analytic system implemented by a server system over the Internet, which may include packing estimation. In one embodiment the analytic service utilizes photo matching algorithms against a database of photographs with associated metadata, and/or one or more websites comprising object associated metadata (such as attributes like dimensions, weight, fragility, etc.). The photographic database may be constantly updated by a web crawler (for example). In another implementation, photo(s) or video (which herein is defined to include multiple still photos) may be analyzed for object representations, and the object representations may be fingerprinted and matched to like object types in an object fingerprint database. In another embodiment, a human operator may identify or assist in identifying objects in the photo or video, and may further assist in identifying “frictions” that may adjust the resource allocation for relocating the object, such as stairways between the object's location and a moving truck location.

In one implementation, a customer needing to move one or more objects either downloads a mobile app or connects to a website via a client device interface. They record video (which may include a single photo, multiple photos, or moving video frames) of item(s) they want to move; provide a source and destination addresses, and add constraints to particular items (i.e. stairs, heavy, fragile, time window etc.). One or more of the constraints may be derived from pictures or video of the location for the move (e.g., video of a path from the object to the front door and out to the street) and/or geolocation data for the object relative to a reference point for the relocation (e.g., a street location of a moving truck). The system transforms these inputs into a resource allocation for moving the object(s) represented in the video.

By way of example, a customer may be prompted to record a photo of one or more object(s) to move using their mobile phone. They are given an option to add or take additional pictures of every object. Each photo (or frames in a recorded streaming video) may be associated with a GPS geolocation signal also recorded by the mobile phone. The customer either enters the address of where to pick-up the objects (source address), or the mobile application measures this input from GPS or other location signals (typically wireless). The customer then inputs the desired date and time of pick-up. Next the customer enters delivery information (destination address) manually, or this signal is measured from GPS or other sources. Lastly, the customer may be prompted if any of the items that they are moving are “hard” to move. If so, they are may be given a number of assumed criteria for why it is “hard” (i.e. extent of stairs, excess weights, requires special equipment, hard to get out, awkward shape/size, needs assembly, needs disassembly, fragile). Other friction factors that may be accounted for in resource allocation include “long carry”, “premium handling”, “specialty equipment” required, e.g. pallet jack or piano sled. The video (continuous stream or multiple photos) and various real-world inputs such as the moving distance, time of day, number of items, and “hard” criteria, and possible other inputs, are transformed by the system into a resource allocation for the move (possibly including packing materials).

### Drawings

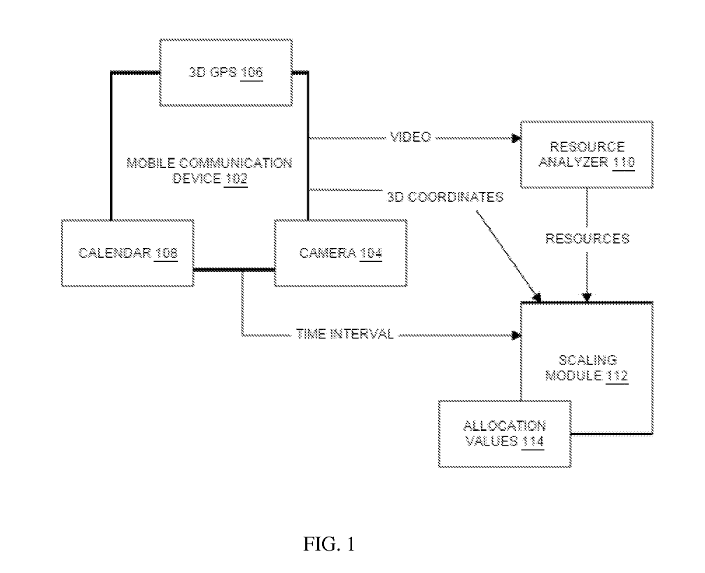

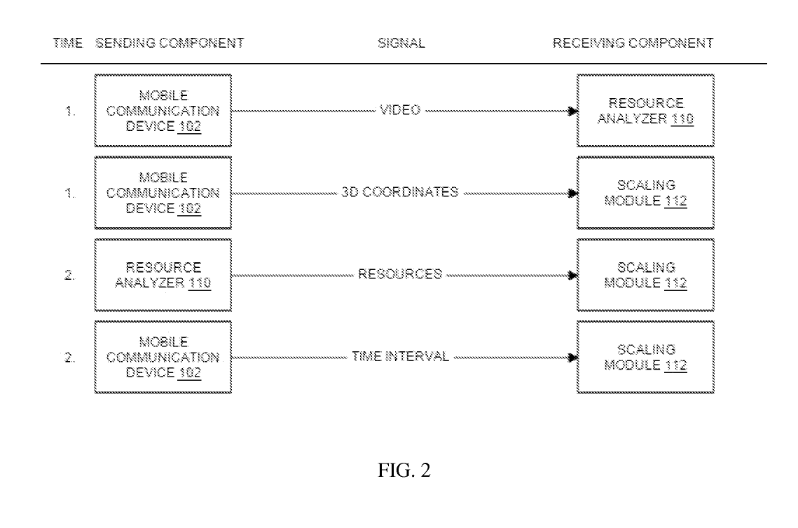

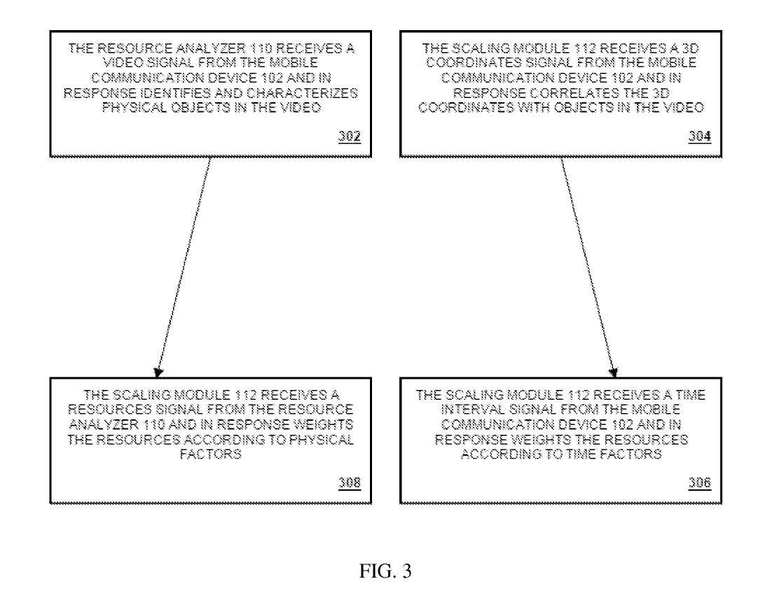

FIG. 1 is a system diagram of an embodiment of a physical resource allocation system. FIG. 2 is an action flow diagram of an embodiment of a physical resource allocation process. FIG. 3 is a flow chart of an embodiment of a physical resource allocation process.

The system comprises mobile communication device 102, camera 104, 3D GPS 106, calendar 108, resource analyzer 110, scaling module 112, and allocation values 114. Other well understood elements of such a system (e.g., wireless interfaces, processors, memories) are omitted so as not to obscure the present description.

The resource analyzer 110 receives video (e.g., from camera 104) from the mobile communication device 102 and in response identifies and characterizes physical objects in the video (302). Physical objects are three dimensional real-world objects represented as two dimensional arrangements of pixels in the video. The resource analyzer 110 transforms identified objects from the video into resource requirements (resources) to physically transport the identified objects.

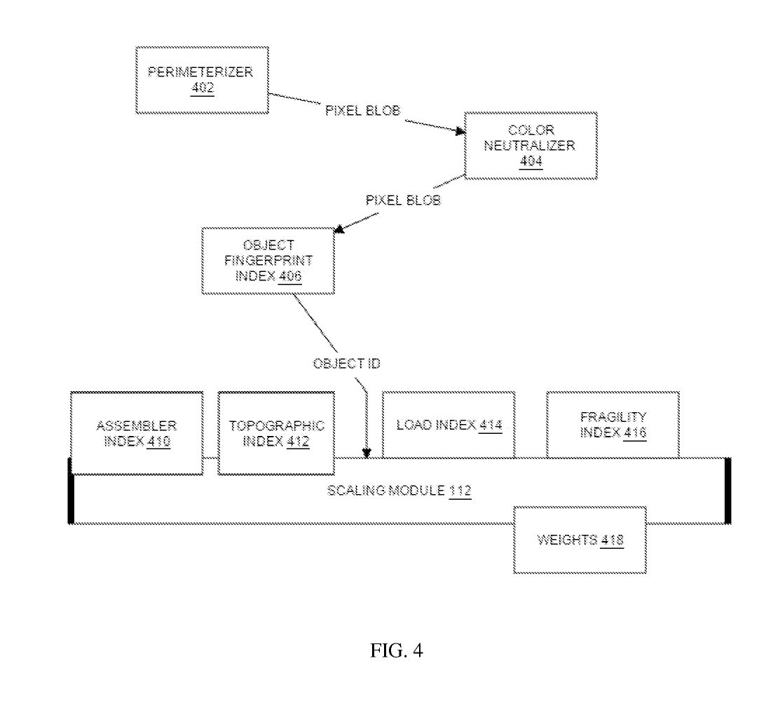

The scaling module 112 receives the resources from the resource analyzer 110 and in response weights the resources according to physical factors (308). Physical factors (see FIG. 4) may include for example object weight, dimensions, and dis-assembly/reassembly required. The scaling module 112 receives a time interval (e.g., from calendar 108) from the mobile communication device 102 and in response weights the resources according to time factors (306). Time factors may include a start and end time (thus defining a time interval) for the physical relocation of the objects. The scaling module 112 further receives 3D coordinates (e.g., from 3D GPS 106) from the mobile communication device 102 and in response correlates the 3D coordinates with objects in the video (304). Thus each object identified in the video is assigned a 3D coordinate (which may include elevation above a reference plane, e.g., location requiring navigation of stairs or an elevator, and this coordinate is applied in conjunction with other variables to weight resource allocation for relocating the object.

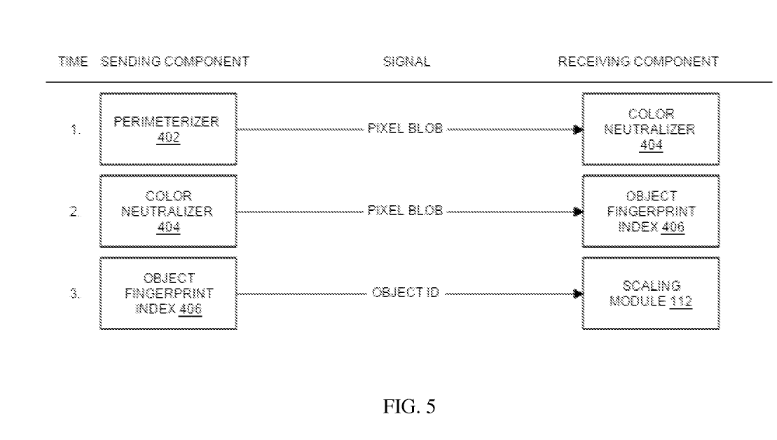

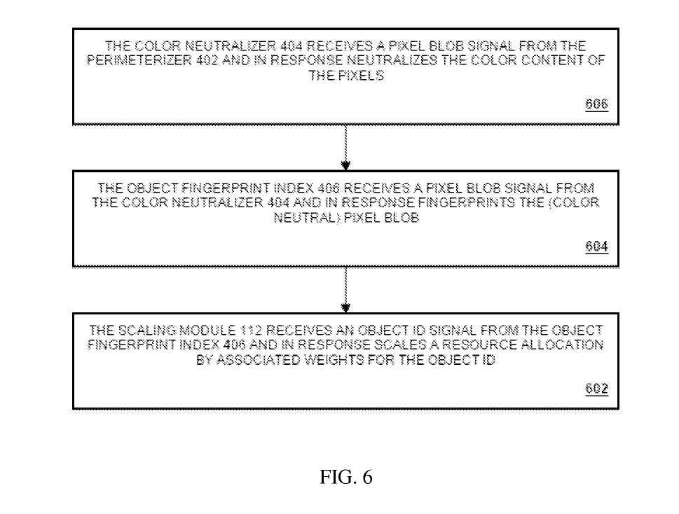

FIG. 4 is a system diagram of an embodiment of a relocation resource allocation system. FIG. 5 is an action flow diagram of an embodiment of a relocation resource allocation process. FIG. 6 is a flow chart of an embodiment of a relocation resource allocation process.

The system comprises perimeterizer 402, color neutralizer 404, object fingerprint index 406, scaling module 112, assembler index 410, topographic index 412, load index 414, fragility index 416, and weights 418. The perimeterizer 402 identifies from the video the perimeters of 3D physical objects represented in 2D in the video. These perimeters may be used to isolate pixel blobs within the video frames.

The color neutralizer 404 receives a pixel blob (pixel subregion of a frame, identified from the video) from the perimeterizer 402 and in response neutralizes the color content of the pixels (606). This neutralization of color content may be part of a more involved process of normalizing the pixels for comparison with stored images of 3D objects, or with fingerprinting the object represented in the pixel blob. Other transformations that may be utilized in normalizing include de-skewing the pixels pixel blob and re-sizing the pixel blob.

The object fingerprint index 406 receives the (normalized) pixel blob from the color neutralizer 404 and in response fingerprints the pixel blob (604). Fingerprinting involves analyzing the pixel blob for identifying characteristics and forming a set of such characteristics, which may then be used to “fit” the pixel blob with a known object having those characteristics. In some embodiments, an image search algorithm may be applied to find images having object representations similar to the one in the pixel blob. In either embodiment the result is an object id, uniquely identifying the object represented in the pixel blob, or at least a rough typing of the object.

The scaling module 112 receives the object id from the object fingerprint index 406 and in response scales a resource allocation by associated weights 418 for the object id (602). Associated weights 418 may include a value for a physical weight of the object or object type, located in load index 414. Another of the associated weights 418 may be a fragility index 416, indicative of an amount of protective resource allocation should be associated with protecting the object in relocation. Another of the associated weights 418 may be a topographic index 412, indicative of a volume or dimensions of the object, e.g. it's size. The topographic index 412 may influence the weights 418 according to a DIM (dimensional) weight of the object or object type, rather than a gross weight. Another of the associated weights 418 may be an assembler index 410, indicative of a resource allocation needed to dis-assemble and re-assemble the object for relocation.

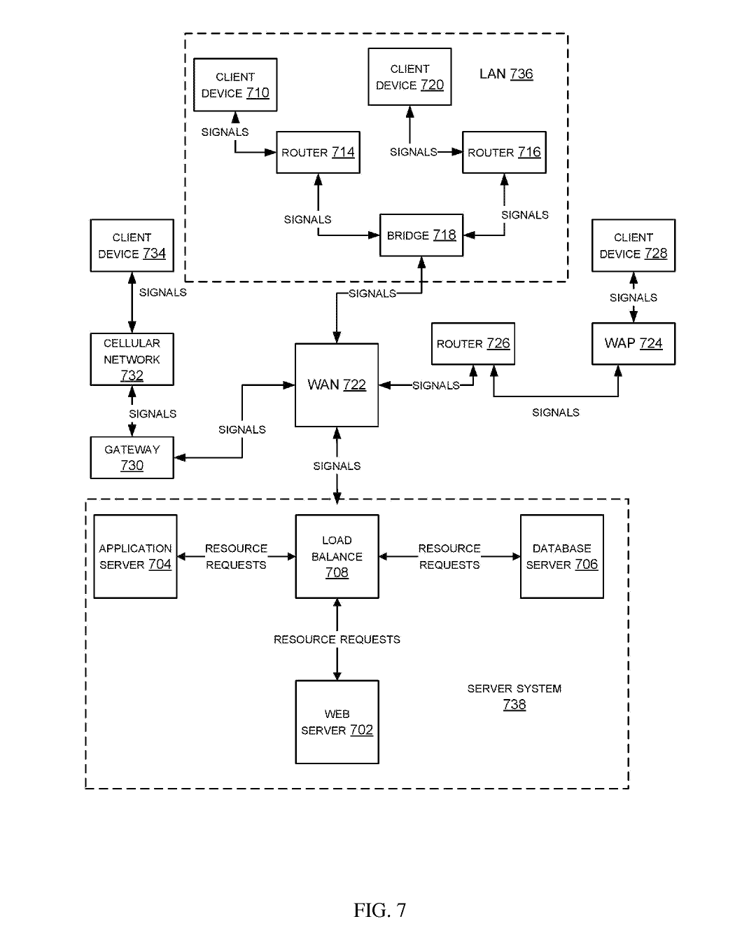

FIG. 7 illustrates a machine system that may implement an embodiment of a resource allocation system. Several network access technologies between client devices and server resources are illustrated, including cellular network 732, LAN 736, and WAP 724. Signals representing server resource requests are output from client devices 710, 720, 728, and 734 to the various access networks, from which they are propagated to a WAN 722 (e.g., the Internet) and from there to a server system. These signals are typically encoded into standard protocols such as Internet Protocol (IP), TCP/IP, and HTTP. When the clients are part of a LAN 736, the signals may be propagated via one or more router 714 716 and a bridge 718. A router 726 may propagate signals from the WAP 724 to the WAN 722. A gateway 730 may propagate signals from the cellular network 732 to the WAN 722. The server system 738 in this example comprises a number of separate server devices, typically each implemented in the separated machine, although this is not necessarily the case. The signals from the client devices are provided via a load balancing server 708 to one or more application server 704 and one or more database server 716. Load balancing server 708 maintains an even load distribution to the other server, including web server 702, application server 704, and database server 706. Each server in the drawing may represent in effect multiple servers of that type. The load balancing server 708, application server 704, and database server 706 may collectively implement an embodiment of the system described herein. The signals applied to the database server 706 may cause the database server 706 to access and certain memory addresses, which correlates to certain rows and columns in a memory device. These signals from the database server 706 may also be applied to application server 704 via the load balancing server 708. Signals applied by the application server 704, via the load balancing server 708, to the web server 702, may result in web page modifications which are in turn communicated to a client device, as described herein in regards to user interface and interaction signals to and from a client device. The system described herein may thus be implemented as devices coordinated on a LAN, or over a wide geographical area utilizing a WAN or cellular network, or over a limited area (room or house or store/bar) utilizing a WAP. Features of client logic to interact with the described system may thus be implemented, for example, as an application (app) on a mobile phone interfacing to a network in one of the manners illustrated in this figure. The system described herein may be implemented as a pure or hybrid peer to peer system in a local or widely distributed area.

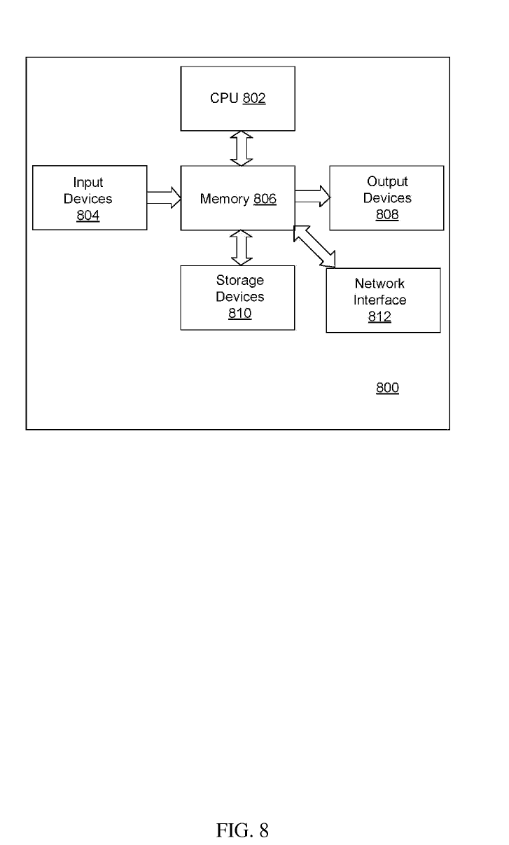

FIG. 8 illustrates a machine which can implement elements of a resource allocation system. Input devices 804 comprise transducers that convert physical phenomenon into machine internal signals, typically electrical, optical or magnetic signals. Signals may also be wireless in the form of electromagnetic radiation in the radio frequency (RF) range but also potentially in the infrared or optical range. Examples of input devices 804 are keyboards which respond to touch or physical pressure from an object or proximity of an object to a surface, mice which respond to motion through space or across a plane, microphones which convert vibrations in the medium (typically air) into device signals, scanners which convert optical patterns on two or three dimensional objects into device signals. The signals from the input devices 804 are provided via various machine signal conductors (e.g., busses or network interfaces) and circuits to memory devices 806. The memory devices 806 is typically what is known as a first or second level memory device, providing for storage (via configuration of matter or states of matter) of signals received from the input devices 804, instructions and information for controlling operation of the CPU 802, and signals from storage devices 810. Information stored in the memory devices 806 is typically directly accessible to processing logic 802 of the device. Signals input to the device cause the reconfiguration of the internal material/energy state of the memory device 806, creating in essence a new machine configuration, influencing the behavior of the device 800 by affecting the behavior of the CPU 802 with control signals (instructions) and data provided in conjunction with the control signals. Second or third level storage devices 810 may provide a slower but higher capacity machine memory capability. Examples of storage devices 810 are hard disks, optical disks, large capacity flash memories or other non-volatile memory technologies, and magnetic memories. The processing logic 802 may cause the configuration of the memory 806 to be altered by signals in storage devices 810. In other words, the CPU 802 may cause data and instructions to be read from storage devices 810 in the memory 806 from which may then influence the operations of CPU 802 as instructions and data signals, and from which it may also be provided to the output devices 808. The CPU 802 may alter the content of the memory of 806 by signaling to a machine interface of memory 806 to alter the internal configuration, and then converted signals to the storage devices 810 to alter its material internal configuration. In other words, data and instructions may be backed up from memory 806, which is often volatile, to storage devices 810, which are often non-volatile. Output devices 808 are transducers which convert signals received from the memory 806 into physical phenomenon such as vibrations in the air, or patterns of light on a machine display, or vibrations (i.e., haptic devices) or patterns of ink or other materials (i.e., printers and 3-D printers). Communication interface 812 receives signals from the memory 806 and converts them into electrical, optical, or wireless signals to other machines, typically via a machine network. Communication interface 812 also receives signals from the machine network and converts them into electrical, optical, or wireless signals to the memory 806.

Embodiments of a resource allocation system have been described. The following claims are directed to said embodiments, but do not preempt or encompass resource allocation in the abstract. Those having skill in the art will recognize numerous other approaches to resource allocation are possible and/or utilized commercially, and which do not utilize the inventive processes and specific interaction of those processes of the claims as an integrated whole, thus precluding any possibility of preemption or encompassing of resource allocation in the abstract. The claimed system is not only configured for non-trivial and unconventional processing, it also improves, in one or more specific ways, the operation of a machine system for resource allocation, and thus distinguishes from other approaches to the same problem/process in how its physical arrangement of a machine system determines the system's operation and ultimate effects on the material environment. Although that any system, process, apparatus or material may ultimately, with enough intellectual reduction, be reduced to basic or fundamental components (e.g., a computer may be reduced to circuits and conductors, a new medicine reduced to known atoms, etc.), described herein are novel and inventive configurations and interoperations of any such components to enable and implement novel and inventive devices and systems of devices that specifically improve the functioning of a resource allocation computer system. The claims are not a mere general linking of an abstract idea to a technology environment, and require more than a generic computer performing generic functions that are well understood and routine and conventional, and previously known to the industry.

It will be further recognized that the claims do not preempt or wholly encompass any fundamental economic practice, idea in and of itself (e.g., a principle, original cause, or motive), or pure mathematical formula or relationship.

References to “one embodiment” or “an embodiment” do not necessarily refer to the same embodiment, although they may. Unless the context clearly requires otherwise, throughout the description and the claims, the words “comprise,” “comprising,” and the like are to be construed in an inclusive sense as opposed to an exclusive or exhaustive sense; that is to say, in the sense of “including, but not limited to.” Words using the singular or plural number also include the plural or singular number respectively, unless expressly limited to a single one or multiple ones. Additionally, the words “herein,” “above,” “below” and words of similar import, when used in this application, refer to this application as a whole and not to any particular portions of this application. When the claims use the word “or” in reference to a list of two or more items, that word covers all of the following interpretations of the word: any of the items in the list, all of the items in the list and any combination of the items in the list, unless expressly limited to one or the other.

“Logic” refers to machine memory circuits, machine readable media, and/or circuitry which by way of its material and/or material-energy configuration comprises control and/or procedural signals, and/or settings and values (such as resistance, impedance, capacitance, inductance, current/voltage ratings, etc.), that may be applied to influence the operation of a device. Magnetic media, electronic circuits, electrical and optical memory (both volatile and nonvolatile), and firmware are examples of logic. Logic specifically excludes pure signals or software per se (however does not exclude machine memories comprising software and thereby forming configurations of matter).

Those skilled in the art will appreciate that logic may be distributed throughout one or more devices, and/or may be comprised of combinations memory, media, processing circuits and controllers, other circuits, and so on. Therefore, in the interest of clarity and correctness logic may not always be distinctly illustrated in drawings of devices and systems, although it is inherently present therein.

The techniques and procedures described herein may be implemented via logic distributed in one or more computing devices. The particular distribution and choice of logic will vary according to implementation.

Those having skill in the art will appreciate that there are various logic implementations by which processes and/or systems described herein can be effected (e.g., hardware, software, and/or firmware), and that the preferred vehicle will vary with the context in which the processes are deployed. “Software” refers to logic that may be readily readapted to different purposes (e.g. read/write volatile or nonvolatile memory or media). “Firmware” refers to logic embodied as read-only memories and/or media. Hardware refers to logic embodied as analog and/or digital circuits. If an implementer determines that speed and accuracy are paramount, the implementer may opt for a hardware and/or firmware vehicle; alternatively, if flexibility is paramount, the implementer may opt for a solely software implementation; or, yet again alternatively, the implementer may opt for some combination of hardware, software, and/or firmware. Hence, there are several possible vehicles by which the processes described herein may be effected, none of which is inherently superior to the other in that any vehicle to be utilized is a choice dependent upon the context in which the vehicle will be deployed and the specific concerns (e.g., speed, flexibility, or predictability) of the implementer, any of which may vary. Those skilled in the art will recognize that optical aspects of implementations may involve optically-oriented hardware, software, and or firmware.

The foregoing detailed description has set forth various embodiments of the devices and/or processes via the use of block diagrams, flowcharts, and/or examples. Insofar as such block diagrams, flowcharts, and/or examples contain one or more functions and/or operations, it will be understood as notorious by those within the art that each function and/or operation within such block diagrams, flowcharts, or examples can be implemented, individually and/or collectively, by a wide range of hardware, software, firmware, or virtually any combination thereof. Several portions of the subject matter described herein may be implemented via Application Specific Integrated Circuits (ASICs), Field Programmable Gate Arrays (FPGAs), digital signal processors (DSPs), or other integrated formats. However, those skilled in the art will recognize that some aspects of the embodiments disclosed herein, in whole or in part, can be equivalently implemented in standard integrated circuits, as one or more computer programs running on one or more computers (e.g., as one or more programs running on one or more computer systems), as one or more programs running on one or more processors (e.g., as one or more programs running on one or more microprocessors), as firmware, or as virtually any combination thereof, and that designing the circuitry and/or writing the code for the software and/or firmware would be well within the skill of one of skill in the art in light of this disclosure. In addition, those skilled in the art will appreciate that the mechanisms of the subject matter described herein are capable of being distributed as a program product in a variety of forms, and that an illustrative embodiment of the subject matter described herein applies equally regardless of the particular type of signal bearing media used to actually carry out the distribution. Examples of a signal bearing media include, but are not limited to, the following: recordable type media such as floppy disks, hard disk drives, CD ROMs, digital tape, flash drives, SD cards, solid state fixed or removable storage, and computer memory.

In a general sense, those skilled in the art will recognize that the various aspects described herein which can be implemented, individually and/or collectively, by a wide range of hardware, software, firmware, or any combination thereof can be viewed as being composed of various types of “ circuitry.” Consequently, as used herein “circuitry” includes, but is not limited to, electrical circuitry having at least one discrete electrical circuit, electrical circuitry having at least one integrated circuit, electrical circuitry having at least one application specific integrated circuit, circuitry forming a general purpose computing device configured by a computer program (e.g., a general purpose computer configured by a computer program which at least partially carries out processes and/or devices described herein, or a microprocessor configured by a computer program which at least partially carries out processes and/or devices described herein), circuitry forming a memory device (e.g., forms of random access memory), and/or circuitry forming a communications device (e.g., a modem, communications switch, or optical-electrical equipment).

Those skilled in the art will recognize that it is common within the art to describe devices and/or processes in the fashion set forth herein, and thereafter use standard engineering practices to integrate such described devices and/or processes into larger systems. That is, at least a portion of the devices and/or processes described herein can be integrated into a network processing system via a reasonable amount of experimentation.

What is claimed is:

1. A machine server system, comprising:
a video processor adapted with logic to identify a physical object representation in a video;
an object fingerprinter adapted to assign an object type to the physical object representation;
a resource allocator adapted to match the object type to pre-defined relocation resource values for physical objects having the object type; and
weighting logic adapted to adjust the pre-defined relocation resource values for physical objects having the object type by an adjustment amount that varies according to geolocation coordinates correlated to the physical object representation.

2. The machine server system of claim 1, further comprising:
a perimeterizer adapted to identify a perimeter of the physical object representation in the video.

3. The machine server system of claim 1, further comprising:
the object fingerprinter adapted to identify a plurality of identification points in the physical object representation and transforming the plurality of identification points in the physical object representation into an object fingerprint.

4. The machine server system of claim 3, further comprising:
the object fingerprinter adapted to compare the object fingerprint to each of a plurality of pre-defined object fingerprints in an object database.

5. The machine server system of claim 1, further comprising:
the weighting logic adapted to vary the adjustment amount according to a two-dimensional distance between the geolocation coordinates correlated to the physical object representation and a relocation reference point.

6. The machine server system of claim 1, further comprising:
the weighting logic adapted to vary the adjustment amount according to an elevation distance between the geolocation coordinates correlated to the physical object representation and a relocation reference point.

7. A method comprising:
identifying a physical object representation in a video;
fingerprinting the physical object representation to form an object fingerprint;
assigning an object type to the physical object representation based on the object fingerprint;
matching the object type to pre-defined relocation resource values for physical objects having the object type; and
adjusting the pre-defined relocation resource values for physical objects having the object type by an adjustment amount that varies according to geolocation coordinates correlated to the physical object representation.

8. The method of claim 7, further comprising:
marking out a perimeter of the physical object representation in the video.

9. The method of claim 7, further comprising:
identifying a plurality of identification points in the physical object representation and transforming the plurality of identification points in the physical object representation into the object fingerprint.

10. The method of claim 9, further comprising:
comparing the object fingerprint to each of a plurality of pre-defined object fingerprints in an object database.

11. The method of claim 7, further comprising:
varying the adjustment amount according to a two-dimensional distance between the geolocation coordinates correlated to the physical object representation and a relocation reference point.

12. The method of claim 7, further comprising:
varying the adjustment amount according to an elevation distance between the geolocation coordinates correlated to the physical object representation and a relocation reference point.

13. A non-transitory computer-readable storage medium having stored thereon instructions including instructions that, when executed by a processor, configure the processor to perform a method comprising:
identifying a physical object representation in a video;
fingerprinting the physical object representation to form an object fingerprint;
assigning an object type to the physical object representation based on the object fingerprint;
matching the object type to pre-defined relocation resource values for physical objects having the object type; and
adjusting the pre-defined relocation resource values for physical objects having the object type by an adjustment amount that varies according to geolocation coordinates correlated to the physical object representation.

14. The non-transitory computer-readable storage medium of claim 13, the method further comprising:
marking out a perimeter of the physical object representation in the video.

15. The non-transitory computer-readable storage medium of claim 13, the method further comprising:
identifying a plurality of identification points in the physical object representation and transforming the plurality of identification points in the physical object representation into the object fingerprint.

16. The non-transitory computer-readable storage medium of claim 15, the method further comprising:
comparing the object fingerprint to each of a plurality of pre-defined object fingerprints in an object database.

17. The non-transitory computer-readable storage medium of claim 13, the method further comprising:
varying the adjustment amount according to a two-dimensional distance between the geolocation coordinates correlated to the physical object representation and a relocation reference point.

18. The non-transitory computer-readable storage medium of claim 13, the method further comprising:
varying the adjustment amount according to an elevation distance between the geolocation coordinates correlated to the physical object representation and a relocation reference point.
